(19) United States
(12) Patent Application Publication
(10) Pub. No.: US 2003/0206767 A1
(43) Pub. Date: Nov. 6, 2003

(54) System and method for fixing an object to a plate

(76) Inventor: Thomas Lecuppe, Montfaucon (FR)

Correspondence Address: STURM & FIX LLP, 206 SIXTH AVENUE, SUITE 1213, DES MOINES, IA, 50309-4076, US

(21) Appl. No.: 10/454,226

(22) Filed: Jun. 4, 2003

Related U.S. Application Data
(63) Continuation of application No. PCT/IB01/02632, filed on Dec. 20, 2001.

(30) Foreign Application Priority Data
Dec. 22, 2000 (FR) FR 0017010

(51) Int. Cl. F16B 7/08

(52) U.S. Cl. 403/188

(57) ABSTRACT

The invention concerns a system for fixing an object to a plate via a washer, wherein the object is linked to the washer and the plate comprises a structure to retain the object by butting the washer against said structure. The invention is characterized in that said structure is a hemispheric or cylindrical conical dome of the plate. The dome has a convex or a concave surface against which the washer is butted. The invention also concerns a method for fixing an object on a plate via a washer designed to be linked to the object, characterized in that it consists in deforming the plate by swaging to provide it with a hemispheric or cylindrical conical dome and in driving the washer relative to the dome to retain the object on the plate by butting the washer against the dome.

The invention relates to a system and a method for fixing an object to a plate and more particularly to a system and a method in which the object is fixed to the plate via a bracing washer.

A system for fixing a tube on a plate via a bracing washer is known, in particular, from the document U.S. Pat. No. 4,667,916.

According to this disclosure, the washer is provided with fingers on an inner circumference and the plate comprises a threaded rod attached by welding and a nut screwed around the threaded rod. The fingers of the inner circumference of the washer are deformed by flexing against the nut when the washer is driven in relative to the threaded rod. The flexing of the fingers of the inner circumference against the nut makes it possible to drive in the washer relative to the threaded rod with relatively little effort compared with the effort necessary for withdrawing the washer from the nut after driving-in and flexing of the fingers. The tube is linked to the washer in order to be retained relative to the plate when the washer is driven in relative to the threaded rod and braced against the nut.

Such a system of fixing by means of an element attached to the plate is costly and requires implementing means which are often difficult to integrate in a production flow.

It should be noted that a bracing washer is well-known per se. Moreover, it is part of the general knowledge of a person skilled in the art that bracing washers are not limited to the washers provided with fingers, also called grooved washers, described in the above-mentioned document.

The bracing of a grooved washer is provided mainly by the flexing of the fingers or lugs. But a washer without fingers is still capable of being braced. A washer of this type is known, in particular, from the linking system between two tubes inserted relative to one another, described in the document EP-A-813,018.

According to this disclosure, the outer tube supports the inner tube via a washer linked to the outer tube and having a central opening with a diameter less than that of the inner tube so as to be braced when the inner tube is forced through the central opening.

The object of the invention is to permit the fixing of an object on a plate via a bracing washer in a simple and economical manner.

To this end, the subject of the invention is a system for fixing an object to a plate via a washer, in which the object is linked to the washer and the plate comprises a structure for retaining the object by bracing of the washer against this structure, characterised in that this structure is a conical, hemispherical or cylindrical dome of the plate.

The conical, hemispherical or cylindrical dome provides a structure integrated in the plate itself and thus makes it possible to dispense with any attached structure for the bracing of the washer. This results in a reduction of the cost of producing the fixing system. The dome integrated in the plate itself permits a separation between the plate and the object which is impervious to fluids, noises, odours or electromagnetic fields. In contrast, a system of fixing by means of a hole requires the provision of additional means to ensure the imperviousness between the plate and the object.

The invention also relates to a method for fixing an object on a plate via a washer designed to be linked to the object, characterised in that the plate is deformed to provide it with a conical, hemispherical or cylindrical dome and the washer is driven in relative to the dome to retain the object on the plate by bracing of the washer against the dome.

The method according to the invention is readily integrated in a production flow. By comparison, a method involving perforation of the plate leads to scrap or a chip which must be removed.

In the case of sheet metal, the deformation is preferably provided by swaging. Generally speaking, the geometry of the deformation is calculated as a function of the mechanical properties of the plate.

Other advantages of the invention will become apparent on reading the description of two embodiments illustrated by the drawings.

FIG. 1 is an exploded view of a fixing system according to the invention in which the plate comprises a conical dome and the washer is grooved.

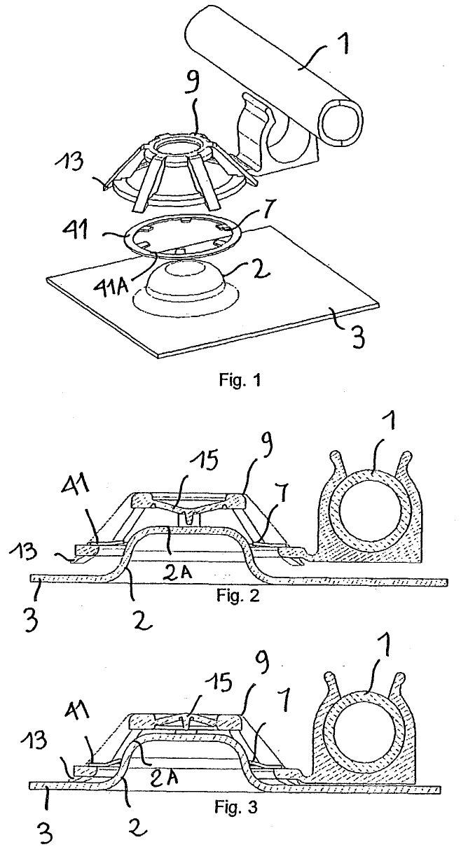

FIG. 2 is a sectional view of the fixing system illustrated in FIG. 1, showing an initial stage of driving in the grooved washer relative to a convex surface of the conical dome.

FIG. 3 is a sectional view of the fixing system illustrated in FIG. 1, showing a final stage of driving in the grooved washer relative to the convex surface of the conical dome.

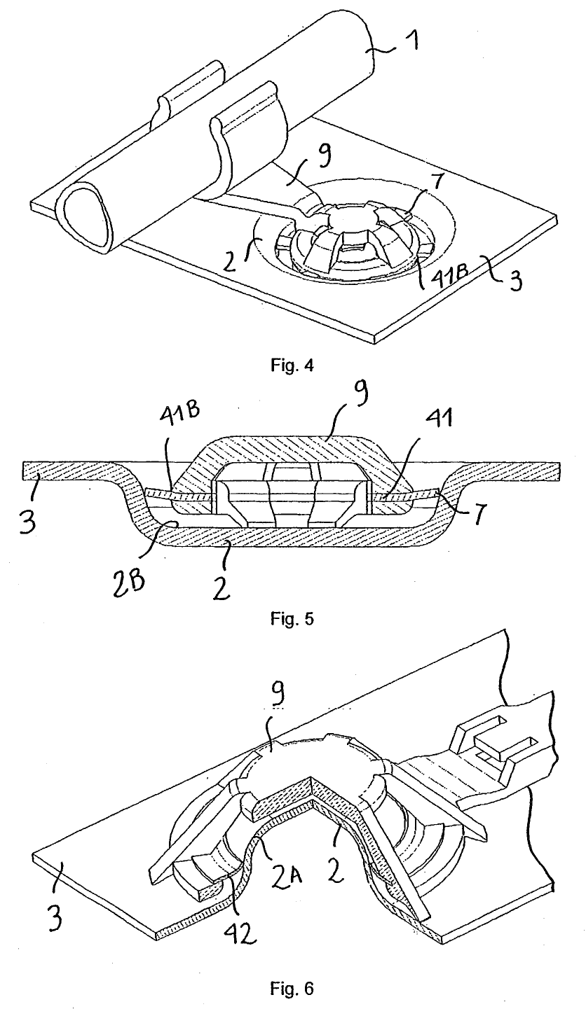

FIG. 4 is a perspective view of a fixing system according to the invention in which the plate comprises a conical dome and the washer is grooved and braced against the concave surface of this dome.

FIG. 5 is a sectional view of the fixing system illustrated in FIG. 4.

FIG. 6 is a partial sectional view of a fixing system according to the invention in which the plate comprises a conical dome and the washer is plain and braced against the convex surface of this dome.

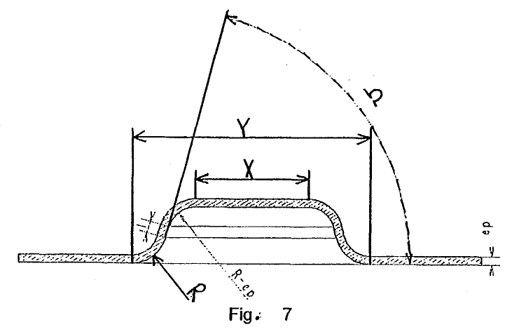

FIG. 7 is a sectional view of the conical dome illustrated in FIGS. 1 to 6, obtained by swaging the plate.

A system for fixing an object to a plate via a grooved washer as illustrated in FIGS. 1 to 5 comprises an object 1, a grooved washer 41 and a plate 3.

FIG. 6 illustrates a system for fixing an object to a plate via a non-grooved washer 42. In this figure, the elements in common with the fixing systems illustrated in FIGS. 1 to 5 bear the same references.

The link between the washer 41,42 and the object 1 is provided by an intermediate part 9 dedicated to holding the object. In this case, the washer 41,42 serves as a support for or is integrated in this intermediate part. The grooved washer 41 or non-grooved washer 42 may also be linked to the object 1 while serving directly as a support for the latter or being integrated therein. If the object to be fixed or the intermediate part are made of plastic, the link to the washer 41,42 is produced for example by moulding the object or the intermediate part around the washer. Provision is also made to produce the link by elastic gripping between the washer and the object to be fixed.

The washer 41 has lugs 7 which are deformed by flexing against the structure 2 of the plate 3 during the driving-in of the washer 41 relative to this structure 2. The bracing of the washer 41 is mainly provided by the flexing of the lugs against the structure 2 of the plate 3. Similarly, the non-grooved washer 42 is braced against the structure 2 of the plate 3 as it is driven in relative to this structure 2.

According to the invention, the structure 2 is a conical, hemispherical or cylindrical dome of the plate 3.

In a first embodiment of the invention, illustrated in FIGS. 1 to 3, the washer 41 is grooved on its inner circumference 41A for bracing against a convex surface 2A of the dome 2 of the plate 3. The grooved washer 41 serves as a support for an intermediate part 9 dedicated to holding the object 1 to be fixed. Stops 13 are provided on the object 1 to be fixed or the intermediate part 9 dedicated to holding the object to be fixed in order to limit the driving-in travel of the grooved washer 41 relative to the dome 2.

Provision is made to equip the intermediate part 9 or the object 1 to be fixed itself with a visual, tactile or sonorous indicator 15 to show that the system is implemented correctly. In the example of FIGS. 1 to 3, the indicator is a bistable cap.

In a second embodiment of the invention, illustrated in FIGS. 4 and 5, the washer 41 is grooved on its outer circumference 41B for bracing against a concave surface 2B of the dome 2 of the plate 3.

In the case of a conical or hemispherical dome, the bracing of the washer 41 by flexing of the lugs 7 increases as the washer 41 is driven in against the convex surface 2A or against the concave surface 2B of the dome.

FIG. 6 shows the non-grooved washer 42 braced against the convex surface 2A of the conical dome 2 of the plate 3. The non-grooved washer may also be braced against the concave surface 2B of the dome 2 of the plate 3.

The use of a conductive bracing washer makes it possible to produce an electrical contact with the concave or convex surface of the dome in order to produce earth or electric potential tapping. In this case, the bracing washer comprises an electrical contactor.

In the case of a metallic dome, provision is preferably made for an anticorrosion coating of the bracing washer, in particular an anticorrosion coating with a galvanic potential less than that of the concave or convex surface of the dome. This coating is called an anodic or sacrificial coating. In this range of sacrificial coatings, provision is made for oxides forming a passivating layer, preferably based on aluminium or zinc.

To fix the object 1 on the plate 3 via the grooved washer 41 or non-grooved washer 42, linked to the object 1, preferably the plate 3 is deformed to provide it with a conical, hemispherical or cylindrical dome 2 and the grooved washer 41 or non-grooved washer 42 is driven in relative to the dome 2 in order to retain the object 1 on the plate by bracing of the grooved washer 41 or non-grooved washer 42 against the dome 2.

In the case of fixing on sheet metal, the parameters and rules of calculation to be observed are the maximum elongation of the sheet metal, the minimum radius of curvature and the minimum relief. By way of example, illustrated in FIG. 7, the sheet metal is deformed by swaging while observing the following parameters: maximum elongation of the sheet metal “A”≦1.3; minimum radius of curvature “R”≧3 mm; minimum swaging relief “α”≧3°; maximum relief at the limit of adhesion “θ”≦25°. A relief angle Ω of between α and θ as close as possible to the limit of adhesion θ is chosen in order to obtain a maximum difference between the diameter X at the vertex of the dome and the diameter Y at the base of the dome. This difference in diameters determines tolerance intervals of the dome and the bracing washer. The value of the angle θ is chosen to obtain the desired driving-in and extracting forces.

1. System for fixing an object (1) to a plate (3) via a washer (41,42), in which the object is linked to the washer and the plate comprises a structure (2) for retaining the object by bracing of the washer against this structure, characterised in that this structure (2) is a conical, hemispherical or cylindrical dome of the plate.

2. Fixing system according to claim 1, characterised in that the dome (2) has a convex surface (2A) against which the washer (41,42) is braced.

3. Fixing system according to claim 1, characterised in that the dome (2) has a concave surface (2B) against which the washer (41,42) is braced.

4. Fixing system according to claim 1, 2 or 3, characterised in that the washer (4) comprises an electrical contactor.

5. Fixing system according to one of claims 1 to 4, characterised in that the washer (41) is grooved.

6. Method for fixing an object (1) on a plate (3) via a washer (41,42) designed to be linked to the object, characterised in that the plate (3) is deformed to provide it with a conical, hemispherical or cylindrical dome (2) and the washer (41,42) is driven in relative to the dome (2) to retain the object (1) on the plate (3) by bracing of the washer (41,42) against the dome (2).

7. Method according to claim 6, characterised in that the washer (41,42) is driven in against a convex surface (2A) of the dome (2) of the plate (3).

8. Method according to claim 6, characterised in that the washer (41,42) is driven in against a concave surface (2B) of the dome (2) of the plate (3).

9. Method according to claim 6, 7 or 8, characterised in that the dome (2) is formed by swaging the plate (3).

10. Method according to any one of claims 6 to 9, characterised in that a grooved washer (41) is used.
